(19) United States
(12) Patent Application Publication
(10) Pub. No.: US 2026/0213607 A1
(43) Pub. Date: Jul. 23, 2026

(54) ASSEMBLY METHOD FOR WIRE-SUSPENDED OIS MOTOR AND WIRE-SUSPENDED OIS MOTOR

(71) Applicant: AAC Microtech (Changzhou) Co., Ltd., Changzhou City (CN)

(72) Inventor: Yuhan Wu, Changzhou (CN)

(21) Appl. No.: 19/326,709

(22) Filed: Sep. 11, 2025

Related U.S. Application Data
(63) Continuation of application No. PCT/CN2025/074230, filed on Jan. 23, 2025.

(51) Int. Cl. H02K 5/22; G02B 27/64; G03B 5/00; H02K 15/40; H04N 23/68

(52) U.S. Cl. CPC H02K 5/225; G02B 27/646; H02K 15/40; G03B 5/00; G03B 2205/0007; G03B 2205/0053; H04N 23/687

(57) ABSTRACT

The present application discloses an assembly method for a wire-suspended OIS motor and a wire-suspended OIS motor. The assembly method includes the following steps: sleeving the positioning hole of the material tape onto the positioning column of the base, such that the first wire suspension hole and the second wire suspension hole are coaxially aligned; fixing a first end of the suspension wire to the first wire suspension hole, and fixing a second end of the suspension wire to the second wire suspension hole; cutting the material tape, to disconnect the second elastic connector from the positioning column; and removing the material tape from the positioning column. One technical effect of the present application is to improve the efficiency of threading the suspension wire and to address performance issues caused by suspension wire threading problems.

### CROSS-REFERENCE TO RELATED APPLICATIONS

This application is a continuation of International Application No. PCT/CN2025/074230, Jan. 23, 2025, the entire contents of which are incorporated herein by reference.

### TECHNICAL FIELD

The present application relates to the field of OIS motors, in particular to an assembly method for a wire-suspended OIS motor and a wire-suspended OIS motor.

### BACKGROUND

The optical image stabilization (OIS) motor can achieve not only vertical (Z-axis) focusing drive but also movement in any direction on the horizontal plane (X-axis and Y-axis). When subjected to external disturbance signals, it promptly compensates to maintain the relative stillness of the captured image, ensuring photo clarity.

The OIS motors primarily utilize various mechanisms such as wire-suspension, ball-bearing, and shape-memory alloy. In a wire-suspended OIS motor, four equal-length suspension wires form a hanging system that drives the movable assembly to move relative to the image sensor plane, thereby achieving image stabilization.

In current wire-suspended OIS motors, the relative positioning between the movable assembly (e.g., bracket, carrier) and the stator component (e.g., base) during wire assembly relies solely on tooling fixtures. This requires meeting not only the spatial (Z-axis) specifications on the drawings but also the XY-plane dimensional tolerances. Due to cumulative tolerances from part variations and fixture inaccuracies, the wire suspension holes on the base and the movable assembly become misaligned (i.e., severe eccentricity), making it difficult to thread the suspension wire through both holes in a single attempt. This significantly increases assembly complexity. Furthermore, severe eccentricity between the wire suspension holes at both ends can easily deform the elastic connectors of the movable assembly during threading, ultimately degrading motor performance.

### SUMMARY

In view of the above problems, the main objective of the present application is to provide an assembly method for a wire-suspended OIS motor and a wire-suspended OIS motor, which can improve the efficiency of threading the suspended wire and solve performance problems caused by threading issues.

To achieve the above objective, according to the first aspect of the present application, an assembly method for a wire-suspended OIS motor is provided, wherein the wire-suspended OIS motor includes a stator assembly, a movable assembly, and a material tape, wherein the stator assembly includes a base, which is provided with a first wire suspension hole on a side facing the movable assembly; the base includes a positioning column adjacent to the first wire suspension hole; the movable assembly includes a suspension wire, a first elastic connector, and a second elastic connector, wherein the first elastic connector is provided with a second wire suspension hole; the first elastic connector is provided on a side of the movable assembly away from the base, and the second elastic connector is provided on a side of the movable assembly adjacent to the base; the material tape is connected to the second elastic connector, and the material tape is provided with a positioning hole; the method including the following steps:
sleeving the positioning hole of the material tape over the positioning column of the base, such that the first wire suspension hole and the second wire suspension hole are coaxially aligned;
fixing a first end of the suspension wire to the first wire suspension hole, and fixing a second end of the suspension wire to the second wire suspension hole;
cutting the material tape, to disconnect the second elastic connector from the positioning column; and
removing the material tape from the positioning column.

As an improvement, the material tape is provided with a cutting region;
when the first end of the suspension wire is fixed to the first wire suspension hole and the second end is fixed to the second wire suspension hole, the cutting region is disconnected.

As an improvement, the number of the positioning columns is 2 to 4, and the base is provided with a square shape with four corners on a side facing the movable assembly;
two of the positioning columns are located at two opposite corners of the base, respectively;
or, three of the positioning columns are respectively located at any three corners of the base;
or, four of the positioning columns are respectively located at the four corners of the base.

As an improvement, each of the positioning columns is located on a 45-degree angle line of the corresponding corners of the base.

As an improvement, a cross-section of the positioning column perpendicular to its central axis is circular, square, or slot-shaped.

As an improvement, the material tape has two connection ends, both of which are connected to the second elastic connector, and the positioning hole is provided in a middle of the material tape;
or, the material tape has one connection end, and the positioning hole is provided on a side of the material tape away from the connection end.

As an improvement, the material tape with the two connection ends has an overall L-shape, and the first wire suspension hole is located on an inner side of the material tape and close to the second elastic connector;
the material tape with one connection end has an overall straight shape.

As an improvement, the movable assembly further includes a bracket and a carrier;
a middle portion of the bracket is provided with a movable through-hole, and the carrier is embedded in the movable through-hole; the bracket is connected to a side of the carrier away from the base through the first elastic connector, the bracket is connected to a side of the carrier close to the base through the second elastic connector.

As an improvement, the bracket is provided with a clearance structure at a position corresponding to the cutting region of the material tape.

As an improvement, the material tape is integrally formed with the second elastic connecting member.

According to the second aspect of the present application, a wire-suspended OIS motor is provided, including:
a housing;
a stator assembly, wherein the housing and the base enclose an accommodating cavity; the stator assembly includes a base, which is provided with a first suspended hole on a side facing a movable assembly; the base is provided with a positioning column, which is located adjacent to the first suspended hole; and
the movable assembly located within the accommodating cavity, and including a suspension wire, a first elastic connector, and a second elastic connector, wherein the first elastic connector is provided with a second wire suspension hole; the first elastic connector is provided on a side of the movable assembly away from the base and the second elastic connector is provided on a side of the movable assembly adjacent to the base;
the movable assembly is connected to the base through the suspension wire, wherein the base and the movable assembly are assembled using the assembly method for the wire-suspended OIS motor described in the first aspect.

The beneficial effects of the present application are as follows: by utilizing the material tape between the base and the first elastic connector for alignment, the first wire suspension hole on the base and the second wire suspension hole on the first elastic connector are coaxially aligned. This simplifies the wire threading operation, allowing the suspension wire to pass straight through both holes vertically in a single action, thereby significantly improving wire threading efficiency.

Furthermore, the assembly method for the wire-suspended OIS motor according to the present application can solve the misalignment issue between the wire suspension holes of the base and the movable assembly caused by tooling fixture positioning. It effectively addresses the wire threading failure problem, thereby improving the wire threading yield rate and eliminating motor performance defects caused by threading issues.

### BRIEF DESCRIPTION OF THE DRAWINGS

To more clearly illustrate the technical solutions of the embodiments of the present application the drawings used in the description of the embodiments will be briefly introduced as follows. Obviously, the drawings described below are merely some embodiments of the present application. For those skilled in the art, other drawings may be obtained based on these drawings without creative labor.

FIG. 1 is a schematic diagram of an overall structure of a wire-suspended OIS motor according to an embodiment of the present application.

FIG. 2 is an exploded view of the wire-suspended OIS motor according to an embodiment of the present application.

FIG. 3 is a structural schematic diagram of a first wire suspension hole and a second wire suspension hole of the wire-suspended OIS motor according to an embodiment of the present application.

FIG. 4 is a structural schematic diagram of the wire-suspended OIS motor according to an embodiment of the present application.

FIG. 5 is a clearance schematic diagram of the wire-suspended OIS motor according to an embodiment of the present application.

FIG. 6 is a structural schematic diagram of a base and a positioning column of the wire-suspended OIS motor according to an embodiment of the present application.

FIG. 7 is an enlarged structural schematic diagram of the positioning column of the wire-suspended OIS motor according to the first embodiment of the present application.

FIG. 8 is an enlarged structural schematic diagram of the positioning column of the wire-suspended OIS motor according to the second embodiment of the present application.

FIG. 9 is an enlarged structural schematic diagram of the positioning column of the wire-suspended OIS motor according to the third embodiment of the present application.

FIG. 10 is a schematic diagram of a material tape of the wire-suspended OIS motor according to an embodiment of the present application.

FIG. 11 is a schematic diagram of the clearance structure of the bracket of the wire-suspended OIS motor according to an embodiment of the present application.

FIG. 12 is a schematic diagram of the material tape of the wire-suspended OIS motor according to another embodiment of the present application.

In the figures: 1, housing; 2, bracket; 3, first elastic connector; 4, magnet; 5, carrier; 6, AF coil; 7, suspension wire; 71, first wire suspension hole; 72, second wire suspension hole; 8, second elastic connector; 9, OIS coil; 10, FPC; 11, base; 12, positioning column; 13, material tape; 131, cutting region; 132, positioning hole; 14, gap; and 15, clearance structure.

### DETAILED DESCRIPTION OF THE EMBODIMENTS

To make the objectives, technical solutions, and advantages of the present application clearer, the various embodiments of the present application will be described in detail below with reference to the accompanying drawings. However, those skilled in the art will understand that many technical details have been provided in the various embodiments of the present application to enable readers to better understand the present application. Nevertheless, the technical solutions claimed by the present application can be achieved even without these technical details and various changes and modifications based on the following embodiments.

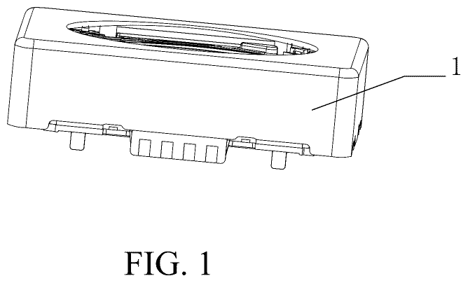

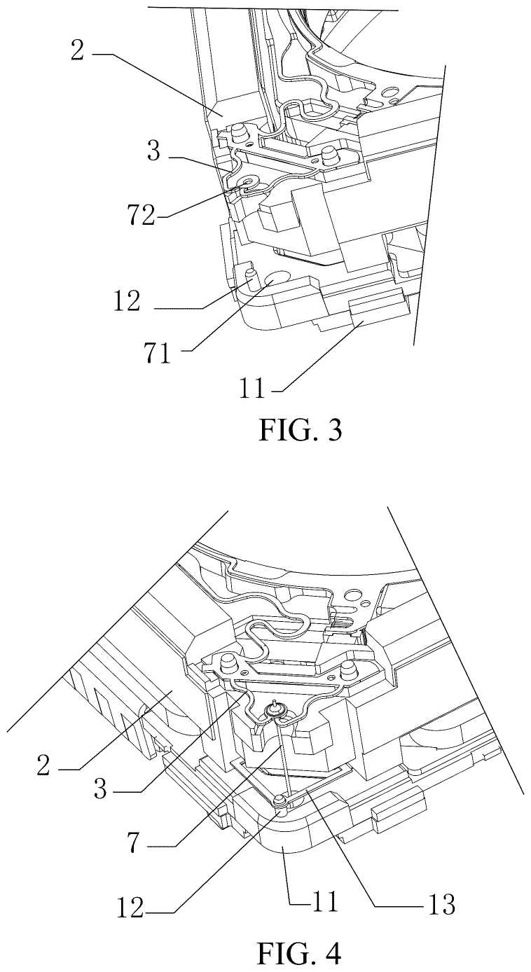

According to the first aspect of the present application, as shown in FIGS. 1 to 4, an assembly method for a wire-suspended OIS motor is provided. The assembly method of the wire-suspended OIS motor provides precise positioning for the suspension wire installation, which not only improves the wire mounting efficiency but also effectively ensures the performance of the wire-suspended OIS motor.

Specifically, the wire-suspended OIS motor includes a stator assembly, a movable assembly, and a material tape 13.

The stator assembly includes a base 11, which is provided with a first wire suspension hole 71 on a side facing the movable assembly. The base 11 is provided with a positioning column 12, which is located adjacent to the first wire suspension hole 71.

The movable assembly includes a suspension wire 7, a first elastic connector 3, and a second elastic connector 8. The first elastic connector 3 is provided with a second wire suspension hole 72. The movable assembly is provided with the first elastic connector 3 on a side away from the base 11, and the movable assembly is provided with the second elastic connector 8 on a side adjacent to the base 11. The material tape 13 is connected to the second elastic connector 8, and the material tape 13 is provided with a positioning hole 132.

More specifically, the assembly method of the wire-suspended OIS motor includes the following steps.
Step S1: sleeving the positioning hole 132 of the material tape onto the positioning column 12 of the base, such that the first wire suspension hole 71 and the second wire suspension hole 72 are coaxially aligned.
Step S2: fixing a first end of the suspension wire 7 to the first wire suspension hole 71, and fixing a second end of the suspension wire 7 to the second wire suspension hole 72.
Step S3: cutting the material tape 13, to disconnect the second elastic connector 8 from the positioning column 12.
Step S4: removing the material tape 13 from the positioning column 12.

In the embodiment of the present application, the parts (i.e., the material tape) between the base 11 and the first elastic connecting member 3 are utilized for alignment, the first wire suspension hole 71 on the base 11 and the second wire suspension hole 72 on the first elastic connector 3 are coaxially aligned. This simplifies the wire threading operation, allowing the suspension wire 7 to pass straight through both holes vertically in a single action, thereby significantly improving the threading efficiency of the suspension wire 7.

Furthermore, the assembly method for the wire-suspended OIS motor according to the present application can solve the misalignment issue between the wire suspension holes 7 of the base 11 and the movable assembly caused by tooling fixture positioning. It effectively addresses the threading failure problem of the suspension wire 7, thereby improving the wire threading yield rate and eliminating motor performance defects caused by threading issues.

In an embodiment, as shown in FIG. 10, the material tape 13 is provided with a cutting region 131.

When the first end of the suspension wire 7 is fixed to the first wire suspension hole 71 and the second end is fixed to the second wire suspension hole 72, the cutting region 131 is disconnected, and the second elastic connector 8 is in a disconnected state from the positioning column 12.

In the above embodiment, by disconnecting the cutting region 131, the functionality of the second elastic connector 8 is ensured without compromising the performance of the wire-suspended OIS motor, while maintaining operational simplicity.

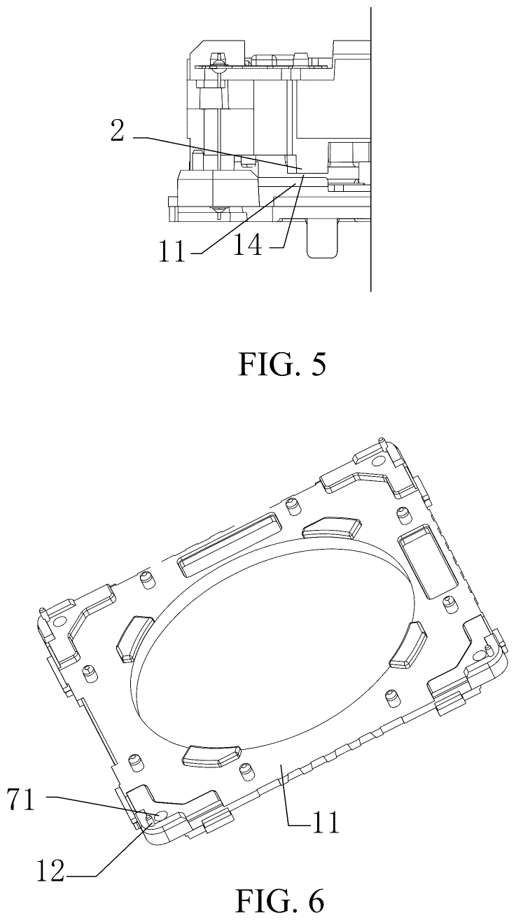

It should be noted that, as shown in FIG. 5, after assembling the movable assembly with the stator assembly, a gap 14 is formed between the bracket 2 and the base 11 to meet the requirement for the movable assembly to move parallel to the optical axis.

In an embodiment, the number of positioning columns 12 is 2 to 4, and the base 11 is provided with a square shape with four corners on a side facing the movable assembly.

Two positioning columns 12 are located at two opposite corners of the base 11, respectively, enabling fewer positioning columns 12 to ensure positioning accuracy between the material tape 13 and the positioning columns 12.

Alternatively, three positioning columns 12 are respectively located at any three corners of the base 11, further enhancing the positioning accuracy between the material tape 13 and the positioning columns 12.

Alternatively, as shown in FIG. 6, four positioning columns 12 are respectively located at the four corners of the base 11, effectively ensuring the positioning accuracy between the material tape 13 and the positioning columns 12.

In an embodiment, each positioning column 12 is located on A 45-degree angle line of the corresponding corners of the base 11. This makes the positioning of the positioning columns 12 reasonable and helps to accurately position the material tape 13 and the second wire suspension hole 72 on the first elastic connecting member 3.

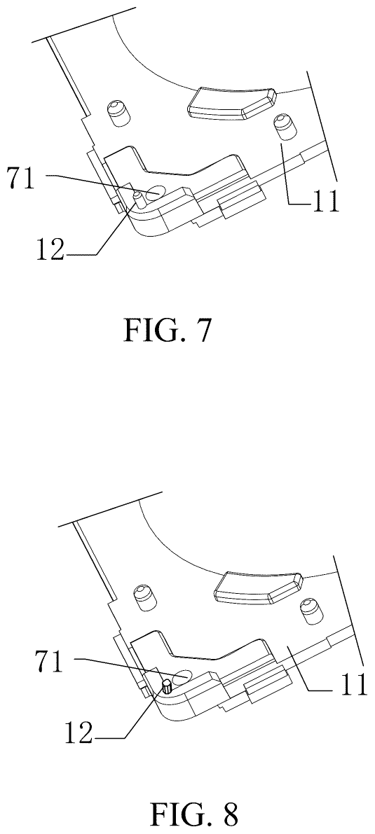

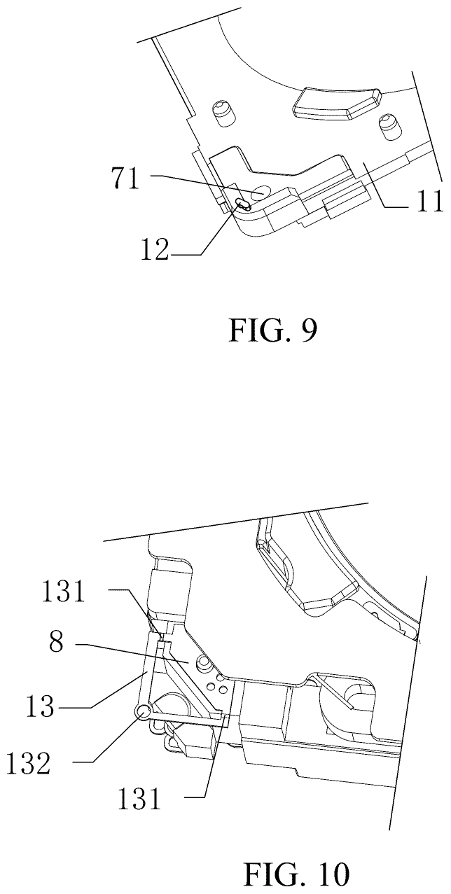

In an embodiment, as shown in FIGS. 7 to 9, a cross-sectional shape of the positioning columns 12 perpendicular to its central axis may be, but is not limited to, circular, square, or slot-shaped. This ensures that the positioning columns 12 are reasonably positioned, enabling accurate positioning of the material tape 13 and the second wire suspension hole 72 on the first elastic connector 3.

In an embodiment, the material tape 13 has two connection ends, both of which are connected to the second elastic connector 8, and the positioning hole 132 is provided in the middle of the material tape 13. This makes the connection between the material tape 13 and the second elastic connector 8 more stable, helping to achieve precise positioning of the second wire suspension hole 72 on the first elastic connector 3.

Alternatively, the material tape 13 has one connection end, and the positioning hole 132 is provided on a side of the material tape 13 away from the connection end. This helps to improve the positioning efficiency of the second wire suspension hole 72 on the first elastic connector 3.

In an embodiment, as shown in FIG. 10, the material tape 13 with two connection ends has an overall L-shape, and the first wire suspension hole 71 is located on the inner side of the material tape 13 and close to the second elastic connector 8. This ensures high connection stability between the material tape 13 and the second elastic connector 8, thereby effectively ensuring the precision of positioning between the positioning hole 132 on the material tape 13 and the positioning column 12.

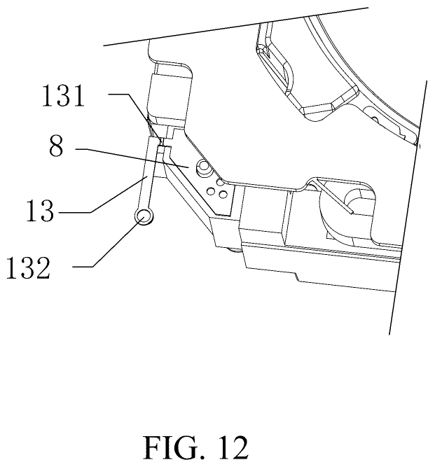

As shown in FIG. 12, the material tape 13 with one connection end has an overall straight shape. This results in a simpler structure for the material tape 13, not only facilitating the connection between the material tape 13 and the second elastic connector 8 but also aiding in cutting the material tape 13 after threading is completed.

In an embodiment, the movable assembly further includes a bracket 2 and a carrier 5.

A middle portion of the bracket 2 is provided with a movable through-hole, and the carrier 5 is embedded within the movable through-hole. The bracket 2 is connected to a side of the carrier 5 away from the base 11 through the first elastic connector 3, and the bracket 2 is connected to a side of the carrier 5 adjacent to the base 11 through the second elastic connector 8.

In the above embodiment, the positions of the first elastic connector 3 and the second elastic connector 8 are reasonably arranged, ensuring the stability of the elastic connection between the carrier 5 and the bracket 2, while also effectively absorbing vibrations and impacts.

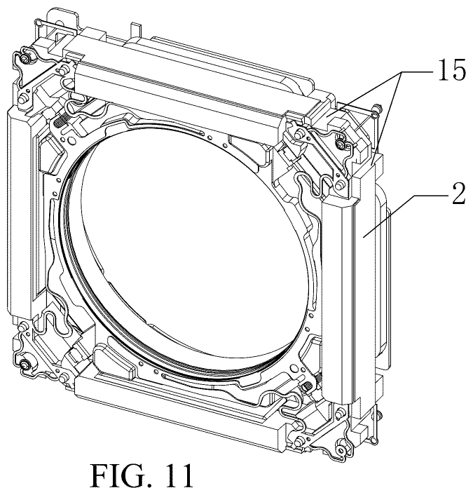

In an embodiment, as shown in FIG. 11, the bracket 2 is provided with a clearance structure 15 at a position corresponding to the cutting region 131 of the material tape 13. The clearance structure 15 may be a notch, a through hole, or a perforated hole, exposing the material tape 13 through the clearance structure 15 to facilitate laser cutting of the material tape 13 through the bracket 2.

In the above embodiment, upon completion of threading the suspension wire 7, i.e., after the two ends of the suspension wire 7 are welded to the first suspension wire 7 of the base 11 and the second wire suspension hole 72 of the first elastic connector 3, the laser can cut the material tape 13 through the clearance structure 15 to ensure the normal function of the second elastic connector 8.

In an embodiment, the material tape 13 and the second elastic connector 8 are integrally formed. This facilitates the processing of the material tape 13 and the second elastic connector 8, reduces processing costs, and ensures the positioning accuracy of the material tape 13.

In an embodiment, the first elastic connector 3 is an F spring.

The second elastic connector 8 is a B spring.

In the above embodiment, the F spring and the B spring ensure the stability of the elastic connection between the carrier 5 and the bracket 2, thereby fixing and adjusting the position of the movable assembly to ensure the quality and stability of the lens imaging.

In a specific embodiment, the movable assembly further includes a magnet 4 and an Auto-Focus (AF) coil 6. The magnet 4 is mounted on an inner surface of the bracket 2, and the AF coil 6 is mounted on an outer surface of the carrier 5, with the AF coil 6 located in the gap between the carrier 5 and the magnet 4. That is, the AF coil 6 is positioned on a side of the magnet 4 close to the carrier 5. The AF coil 6 is primarily configured to achieve autofocus (AF) functionality. When the AF coil 6 is energized, it interacts with the magnet 4 to generate an electromagnetic force, thereby driving the bracket 2 to move back and forth along the optical axis, thus achieving autofocus. Furthermore, by controlling the magnitude and direction of the current in the AF coil 6, the focal length of the lens can be precisely adjusted.

For example, the stator assembly also includes a flexible printed circuit (FPC) 10 and an OIS coil 9. The FPC 10 is mounted on the base 11, and the OIS coil 9 is positioned on the FPC 10. When assembling the movable assembly onto the stator assembly, the OIS coil 9 is located below the magnet 4. The OIS coil 9 is configured to achieve optical image stabilization (OIS) functionality. When the OIS coil is energized, it interacts with the magnet 4 to generate electromagnetic force, causing the bracket 2 to move back and forth along any direction perpendicular to the optical axis. This movement compensates for external vibrations during shooting (such as hand shake), thereby maintaining image clarity. The OIS coil 9 works in conjunction with the AF coil 6 to ensure stable focusing of the lens during shooting and reduce the impact of vibrations.

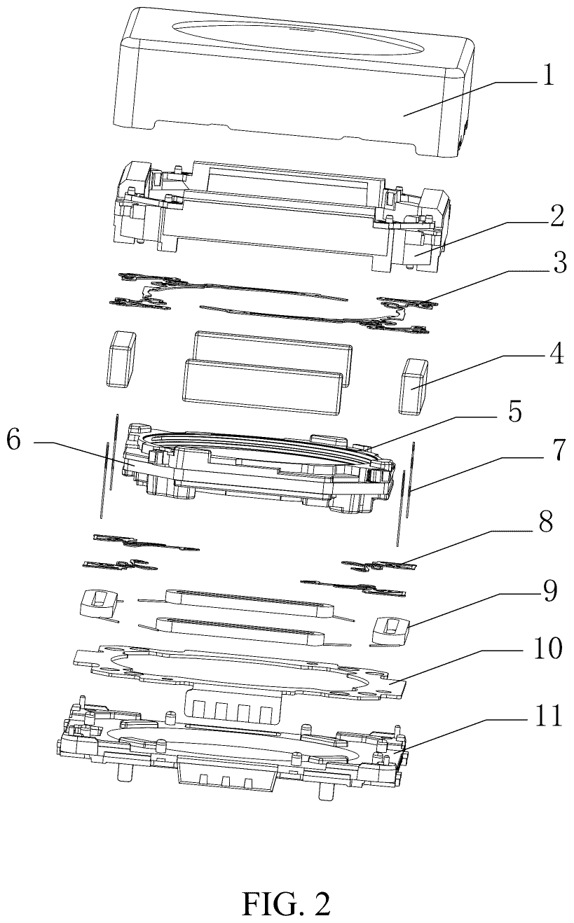

According to the second aspect of the present application, as shown in FIGS. 1 and 2, a wire-suspended OIS motor is provided, including:

a housing 1;

a stator assembly, wherein the housing 1 and the base 11 form an enclosure cavity; the stator assembly includes a base 11, which is provided with a first wire suspension hole 71 on a side facing a movable assembly; the base 11 is provided with a positioning column 12, which is located adjacent to the first wire suspension hole 71; and

the movable assembly located within the accommodating cavity, the including a suspension wire 7, a first elastic connector 3, and a second elastic connector 8, with the first elastic connector 3 being providing with a second wire suspension hole 72. The movable assembly is provided with the first elastic connector 3 on the side away from the base 11, and the second elastic connector 8 on the side adjacent to the base 11;

The movable assembly is connected to the base 11 through the suspension wire 7. The base 11 and the movable assembly are assembled using the assembly method for the wire-suspended OIS motor described in the first aspect.

In the above embodiment, the wire-suspended OIS motor is reasonably designed, significantly improving the efficiency of threading the suspension wire 7 while ensuring the installation accuracy of the suspension wire 7, thereby effectively ensuring the performance of the wire-suspended OIS motor.

It should be noted that in existing wire-suspended OIS motors, when the suspension wire is severely eccentric relative to the holes at both ends, the wire threading process can easily cause deformation of the first elastic connector (e.g., spring F). Furthermore, even if the suspension wire passes through the holes when eccentric, the suspension wire support system will pull the entire movable assembly out of alignment, causing the OIS unit to become eccentric in the XY plane, thereby affecting motor performance.

In the present application, the wire-suspended OIS motor achieves concentricity between the first wire suspension hole 71 on the base 11 and the second wire suspension hole 72 on the first elastic connector 3 through the cooperation of components (the positioning column 12 on the base 11 cooperates with the material tape 13 on the second elastic connector 8). When the suspension wire 7 passes through the holes, it can be quickly and effectively threaded, effectively addressing the following issues:
1. The issue of the suspension wire not being able to pass through due to the first wire suspension hole on the base not being concentric with the second wire suspension hole on the first elastic connector (e.g., F spring). 2. Improving the efficiency of threading the suspension wire. 3. Effectively addressing deformation of the first elastic connector caused by threading the suspension wire, reducing performance issues such as eccentric travel, center offset, and linearity. 4. Effectively addressing the issue of the suspension wire being tilted after threading.
1. The issue of suspension wire threading failure caused by misalignment between the first wire hole on the base and the second wire hole on the first elastic connector (e.g., F-shaped spring) is solved. 2. The efficiency of suspension wire threading is improved. 3. The deformation of the first elastic connector during wire threading are effectively prevented, thereby reducing performance defects such as stroke eccentricity, center offset, and linearity deviations. 4. Post-threading wire tilt issues are effectively eliminated.

In a specific embodiment, the assembly process for the wire-suspended OIS motor is as follows:

First, the OIS coil 9 is fixed to the FPC 10, and the FPC 10 is installed on the base 11. The OIS coil 9, the FPC 10, and the base 11 together form the stator assembly.

Second, the magnet 4 is fixed to the bracket 2, and the magnet 4 and bracket 2 together form the magnetic circuit semi-finished product.

Third, the carrier 5, the first elastic connector 3, the second elastic connector 8, and the magnetic circuit semi-finished product are assembled together to form the AF component semi-finished product.

Next, the AF component semi-finished product, the stator assembly, and the suspension wire 7 are assembled together to form the OIS semi-finished product. In this process, no fixtures are required to position the bracket 2, the first elastic connector 3 (e.g., F spring), and the base 11. Instead, the material tape 13 connected to the second elastic connector 8 and the positioning column 12 can be used to align the first wire suspension hole 71 of the base 11 with the second suspension wire 7 of the first elastic connector 3, making the process of threading the suspension wire 7 simpler and significantly improving the success rate of threading the suspension wire 7. Additionally, this reduces deformation caused by the suspension wire 7 contacting the first elastic connector 3 and failing to pass through the second wire suspension hole 72, thereby improving the efficiency of threading the suspension wire 7 and reducing performance issues caused by suspension wire threading problems.

Finally, the OIS semi-finished product is assembled with the housing 1 to form the finished motor (i.e., the wire-suspended OIS motor).

Those skilled in the art will understand that the above embodiments are specific implementations of the present application, and in actual application, various changes may be made in form and detail without departing from the spirit and scope of the present application.

What is claimed is:

1. An assembly method for a wire-suspended OIS motor, wherein the wire-suspended OIS motor comprises a stator assembly, a movable assembly, and a material tape, wherein the stator assembly comprises a base, which is provided with a first wire suspension hole on a side facing the movable assembly; the base comprises a positioning column adjacent to the first wire suspension hole; the movable assembly comprises a suspension wire, a first elastic connector, and a second elastic connector, wherein the first elastic connector is provided with a second wire suspension hole, the first elastic connector is provided on a side of the movable assembly away from the base, and the second elastic connector is provided on a side of the movable assembly adjacent to the base; the material tape is connected to the second elastic connector, and the material tape is provided with a positioning hole; the method comprises:
sleeving the positioning hole of the material tape onto the positioning column of the base, such that the first wire suspension hole and the second wire suspension hole are coaxially aligned;
fixing a first end of the suspension wire to the first wire suspension hole, and fixing a second end of the suspension wire to the second wire suspension hole;
cutting the material tape, to disconnect the second elastic connector from the positioning column; and
removing the material tape from the positioning column.

2. The assembly method for the wire-suspended OIS motor of claim 1, wherein the material tape is provided with a cutting region;
when the first end of the suspension wire is fixed to the first wire suspension hole and the second end is fixed to the second wire suspension hole, the cutting region is disconnected.

3. The assembly method for the wire-suspended OIS motor of claim 1, wherein the number of the positioning columns is 2 to 4, and the base is provided with a square shape with four corners on a side facing the movable assembly;
two of the positioning columns are located at two opposite corners of the base, respectively;
or, three of the positioning columns are respectively located at any three corners of the base;
or, four of the positioning columns are respectively located at the four corners of the base.

4. The assembly method for the wire-suspended OIS motor of claim 3, wherein each of the positioning columns is located on a 45-degree angle line of the corresponding corners of the base.

5. The assembly method for the wire-suspended OIS motor of claim 1, wherein a cross-section of the positioning column perpendicular to its central axis is circular, square, or slot-shaped.

6. The assembly method for the wire-suspended OIS motor of claim 1, wherein the material tape has two connection ends, both of which are connected to the second elastic connector, and the positioning hole is provided in a middle of the material tape;
or, the material tape has one connection end, and the positioning hole is provided on a side of the material tape away from the connection end.

7. The assembly method for the wire-suspended OIS motor of claim 6, wherein the material tape with the two connection ends has an overall L-shape, and the first wire suspension hole is located on an inner side of the material tape and close to the second elastic connector;
the material tape with one connection end has an overall straight shape.

8. The assembly method for the wire-suspended OIS motor of claim 2, wherein the movable assembly further comprises a bracket and a carrier;
a middle portion of the bracket is provided with a movable through-hole, and the carrier is embedded in the movable through-hole; the bracket is connected to a side of the carrier away from the base through the first elastic connector, the bracket is connected to a side of the carrier close to the base through the second elastic connector.

9. The assembly method for the wire-suspended OIS motor of claim 8, wherein the bracket is provided with a clearance structure at a position corresponding to the cutting region of the material tape.

10. The assembly method for the wire-suspended OIS motor of claim 1, wherein the material tape is integrally formed with the second elastic connector.

11. A wire-suspended OIS motor, comprising
a housing;
a stator assembly, wherein the housing and the base enclose an accommodating cavity; the stator assembly comprises a base, which is provided with a first suspended hole on a side facing a movable assembly; the base is provided with a positioning column, which is located adjacent to the first suspended hole; and
the movable assembly located within the accommodating cavity, and comprising a suspension wire, a first elastic connector, and a second elastic connector, wherein the first elastic connector is provided with a second wire suspension hole; the first elastic connector is provided on a side of the movable assembly away from the base and the second elastic connector is provided on a side of the movable assembly adjacent to the base;
the movable assembly is connected to the base through the suspension wire; wherein the base and the movable assembly are assembled using the assembly method for the wire-suspended OIS motor of claim 1.
